(19) United States
(12) Patent Application Publication
(10) Pub. No.: US 2007/0193871 A1
(43) Pub. Date: Aug. 23, 2007

(54) AUTOMATED SOLVENT EVAPORATION SYSTEM

(76) Inventors: Jeffrey C. Wiseman, Auxvasse, MO (US); L. David Wallen, Columbia, MO (US)

Correspondence Address: LATHROP & GAGE LC, 4845 PEARL EAST CIRCLE, SUITE 300, BOULDER, CO, 80301, US

(21) Appl. No.: 11/676,205

(22) Filed: Feb. 16, 2007

Related U.S. Application Data
(60) Provisional application No. 60/773,880, filed on Feb. 16, 2006.

(51) Int. Cl. B01D 5/00

(52) U.S. Cl. 202/185.3

(57) ABSTRACT

A system provides for automated control of solvent evaporation, such as may be done for solvent exchange in a solvent that contains analytes or extractants. The automated control is able to ascertain and take appropriate action when a solvent is boiling, when the extractants are free or dry of the solvent, and when there is thermal cycling of the solvent.

### RELATED APPLICATIONS

This application claims benefit of priority to U.S. Provisional Application Ser. No. 60/773,880 filed Feb. 16, 2006, the disclosure of which is incorporated by reference to the same extent as though fully replicated herein.

### BACKGROUND

1. Field of the Invention

The invention pertains to solvent evaporation systems and, particularly, the removal of solvent for active-controlled retention of analytes or extractants.

2. Description of the Related Art

Solvents are often used to retain analytes, carry the products of chemical reactions, or in such extraction processes as two-phase extractions. Processing of the solutions sometimes calls for concentration of the analytes, extractants, or reaction products by the removal of solvent. This concentration processing may cause a number of problems, such as the well-known ‘bumping’ phenomenon where the solvent erupts in a violent boiling mode. In other aspects where the evaporation is done by heating, the removal of solvent may proceed to a point where the analytes, extractants, or reaction products fall out of solution and begin to solidify. In these circumstances due care must be taken not induce thermal damage to the analytes, extractants, or reaction products. The process of solvent removal may be done by hand, but it is especially problematic to implement solvent removal in an automated system that overcomes these problems.

U.S. Pat. No. 5,176,799 to Roe et al. discloses an evaporator with a solvent recovery feature An evaporation apparatus includes a vessel with an opening at the top thereof that forms an evaporation chamber to hold a liquid composition. A condenser assembly disposed above and hermetically sealed to the vessel to provide a wall defining a condensation chamber communicating with the evaporation chamber through the opening, an accumulator for receiving liquid condensed on the wall, and a drain for removing liquid received by the accumulator. A fluid drive is disposed above the condenser assembly and adapted to produce fluid flow downwardly through the condensation chamber and into contact with the liquid composition in the evaporation chamber, then upwardly into the condensation chamber. A heating mechanism heats the liquid composition in the evaporation chamber so as to cause evaporation thereof. A cooling device cools the wall so as to condense vapors thereon, where such vapors accompany the fluid flowing upwardly from the evaporation chamber.

U.S. Pat. No. 4,465,554 to Glass discloses an apparatus for evaporating liquid fractions. The apparatus includes a nozzle from which a hot stream of non-reactive gas is directed onto the surface of the fraction that is to be evaporated, while the fraction and the nozzle are thermally insulated and sealed from the surrounding atmosphere. The evaporation process is governed by electronic controls.

### SUMMARY

The present instrumentalities overcome the problems outlined above and advance the art by providing an automated system and method for solvent removal.

In one aspect, this is achieved by use of a multi-mode automated evaporator system for use in the concentration of fluids containing volatile analytes or other material and their subsequent solvent exchange and transfer to a vial. The system may be selected for use inline with a fluid stream, such as a chromatography process, where the system is isolated from a flowing fluid in such a way that the concentration procedure does not impair the overall flowing stream process.

In another mode, the evaporator system may receive fluid directly from sample containers for concentration via positive pressure or negative pressure. The evaporator may either push or pull the fluid from the vessels to act as an automated bulk fluid concentrator. The system receives the fluid from the in-line process or container and is isolated. The fluid is then pulled into the evaporation vessel with negative pressure. Positive pressure may be added to assist in introducing the fluid to the vessel. The fluid is then concentrated in the evaporation vessel. The system will continue to receive sample until it is signaled that the fluid stream necessary for evaporation is complete. The system has liquid sensors to detect the presence of liquid so that temperature and vacuum zones are created. These zones allow the user to control the process temperature and vacuum pressure depending on where the fluid is detected. When all the fluid is collected, a final concentration and solvent exchange can be programmed. The fluid can be brought to a final volume in the same fluid or switched to another fluid. The final fluid is then transferred to a storage vial for use later. The system then undergoes a vigorous rinse process before receiving another fluid stream with out the first process affecting the next. The system utilizes feedback from data and sensors to enhance the automation of the system, the system safety, and the recovery of volatile analytes. Example applications are the concentration of analytes present in GPC Cleanup Chromatography effluent or bulk concentration of environmental samples.

### BRIEF DESCRIPTION OF THE DRAWINGS

FIG. 1 shows an automated evaporation system;

FIG. 2 shows fluid sensors around the evaporation vessel;

FIG. 3 shows an optimized placement as the off center location of negative pressure po0t for turbulence of the evaporating fluid and rinse solutions;

FIG. 4 shows a balancing port for isolation of the solvent delivery from the evaporation process;

FIG. 5 shows of the circuit and feedback for detection of failed heater element or open circuit;

FIG. 6 is a flow diagram of turbulent rinsing;

FIG. 7 is a graph showing the change over in temperature during solvent exchange in context of scaled average power input, system set points, and liquid temperature in a multi-solvent system undergoing fractionation under automated control over time;

FIG. 8A is a graph showing the temperature of dichloromethane (DCM) solvent in context of a PWM-based scaled average power system input under automated control;

FIG. 8B is a graph showing the temperature of ethyl acetate solvent in context of a PWM-based scaled average power system input under automated control;

FIG. 8C is a graph showing the temperature of cyclohexane solvent in context of a PWM-based scaled average power system input under automated control;

FIG. 8D is a graph showing the temperatures of ethyl acetate/Cyclohexane 1:1 solvent in context of a PWM-based scaled average power system input under automated control;

FIG. 9 is a graph showing power limiting to prevent thermal cycling under automated control;

FIG. 10 is a graph showing the detection of complete fluid dryness under automated control, wherein dryness is indicated by a steep drop in the required power input to maintain a given temperature, as is also evident from a derivative of average power input taken with respect to time;

FIG. 11 is a graph showing analog to digital signal conversion values for boiling detection; and

FIG. 12 shows a transport tube conFig.d with a flow sensor for detecting the presence or non presence of gas, fluid, or intermixed gas and fluid.

### DESCRIPTION

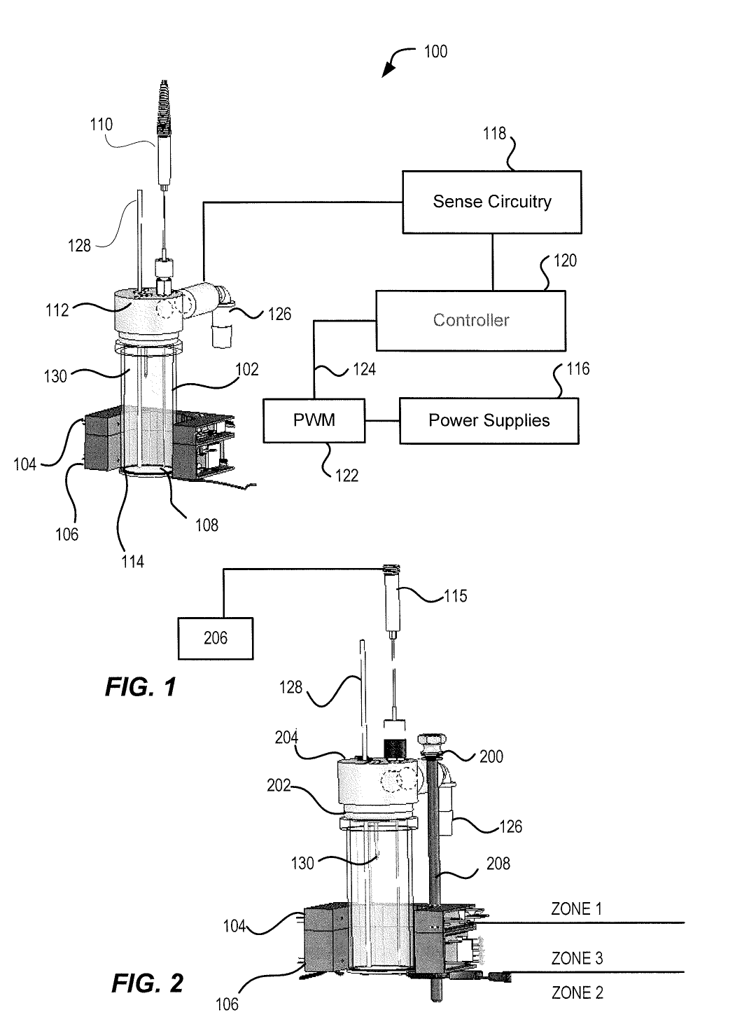

There will now be shown and described, according to FIG. 1, a system for solvent evaporation that contains an automated control system for determining that solvent exchange is complete in a multi-solvent mixture. Evaporation system 100 includes a vessel 102 that contains a solvent, which contains other material, such as analytes, extractants, or reaction products (not shown). Sensors 104, 106 include level sensors disbursed on vessel 102 to measure the fluid properties of those contents. Sensor 108 monitors the temperature of vessel 102. Sensor 110 is optionally used to monitor temperature of the multi-solvent mixture internally. Sensor 112 monitors internal pressure of vessel 102. A heater 114 provides energy transfer to the multi-solvent mixture within vessel 102. A power supply 116 drives the heater 114 and powers the system 100. Sense circuitry 118 receives and interprets signals as values from sensors 104, 106, 108, 110, 112, transmitting the data to controller 120. The controller 120 monitors temperature, energy, fluid level, and/or pressure signals. The power supply 116 drives a pulse width modulation device 122 that controls the amount of power applied to heater 114 by modulation of the pulse width of the applied power. In one embodiment, the applied power may be DC current that is applied in a step-pulse with increments of applied power being separated by a periodic time interval. Controller 120 is calibrated by program instructions to deliver power according to a temperature setpoint that is associated with a periodic separation of these power pulses. Feedback signals on line 124 pertain to power consumption through the PWM device 122. These signals may represent, for example, voltage, amperage, and/or power, which controller 120 uses to adjust the power consumption. Tubing 126 receives solvent vapors for vapor and liquid discharge through a vacuum pump (not shown) that may be used to facilitate solvent evaporation by lowering pressure within vessel 102 to a predetermined level that is programmed into controller 120. A sample transfer tubing 128 may be used to collect samples of fluid from within vessel 102. Injection tubing 130 may be used to inject or introduce fluids into the vessel 102. The controller 120 is conFig.d with program instructions and circuitry to automate the removal of solvent from vessel 102 according to the instrumentalities discussed below.

FIG. 2 provides additional detail with respect to the vessel 102. A manifold 200 and O-ring 202 seal the top 204 of vessel 102 to provide a lid that communicates tubing 126, sample transfer tubing 128, and injection tubing 130 to the interior of vessel 102. By way of example, a fluid stream may be introduced through tubing 130 from an inline process or container (not shown). Once all the fluid is collected, the sample is transferred through tubing 128 to a storage vessel 206. Sensors 104 and 106 can be adjusted to a desired level using adjustment rod 208 to define regions that pertain to sensors 104 and 106 according to labeled Zone 1, Zone, 2, and Zone 3. Each Zone creates a region that is controlled through controller 120 for pressure and rate of energy that applied through the PWM 122. Sensor 106 may be selectively controlled through the controller 120 to define and/or determine the final level endpoint after the fluid is collected.

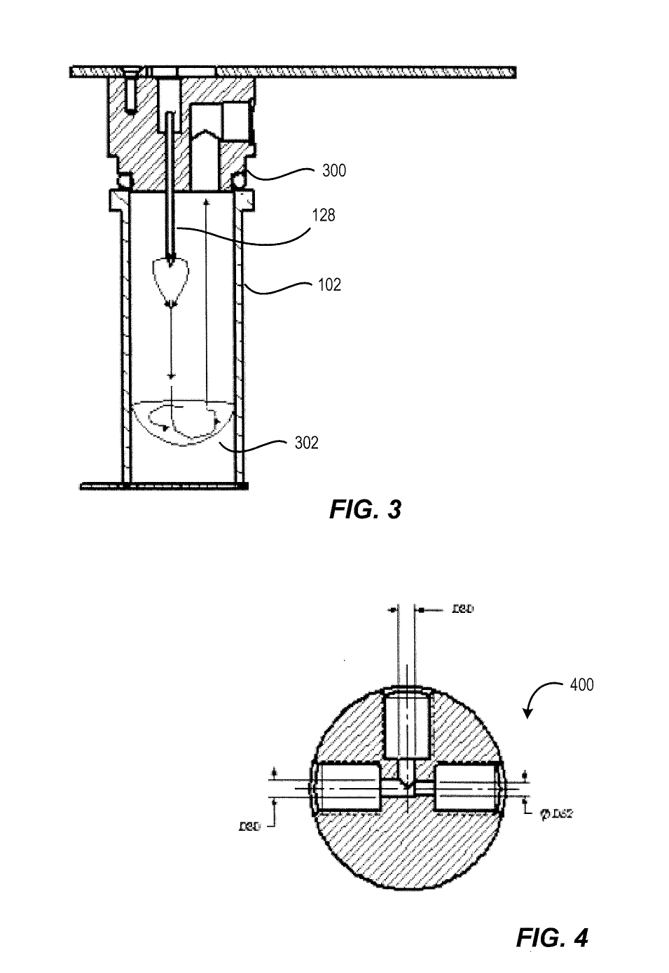

FIG. 3 is a midsectional view of vessel 102 showing an optimized placement as an off-center location for a negative pressure port 300 that turbulates the evaporating fluid and rinse solutions within vessel 102. The negative pressure port 300 is placed to flow in a direction that is off center or transversely of the axis of symmetry of vessel 102. The fluid stream injection tubing 128 is placed to inject in the center or generally parallel to the axis of symmetry. Negative pressure is applied to port 300 while positive fluid or air pressure is introduced through tubing 128. The placement of tubing 128 and port 300 in these orientations and at these conditions causes a flow imbalance within vessel 102 that imparts a fluidic mixing action without the aid of a mechanical stirring mechanism. The flow imbalance through tubing 128 and port 300 may be adjusted by changing a flow restriction (not shown) on either or both tubing 128 and 300. Flow entering the tubing 128 creates a downward force in the general center of vessel 102, while flow being pulled through port 300 pulls upward at the circumference of vessel 102. This opposition of forces is useful in rinsing vessel 102 between introduction periods of the collected fluid stream to keep sample materials dissolved in the fluid 302 inside vessel 102. During the final rinsing period of vessel 102 to remove the contents thereof, the imbalance between tubing 128 and port 300 is increased to a level that causes turbulence inside vessel 102 and facilitates the cleaning of vessel 102.

FIG. 4 shows a flow balancing tee 400 that may be used in top 204 to isolate the fluid delivery of an inline process from the evaporation process of the system 100. An entrance port 402, exit 404, and evaporation process port 406 are connected by conduit 408. The evaporation process port 406 is used to move fluid to the evaporation process within vessel 102.

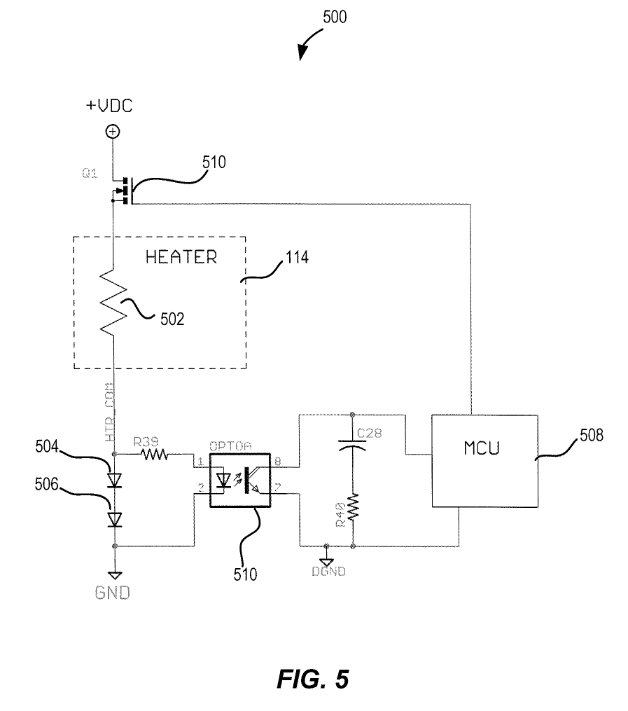

FIG. 5 shows control circuitry 500 that may be used to detect a failure or open circuit in the heater 114. The heater 114 is powered by applying voltage to a resistive heater element 502 and dual inline diodes 504 and 506 according to optimization principles that are discussed below. The modulating circuitry unit 508 controls switch 510 at a p-reset or variable rate according to instructions from controller 120. During the time period that switch 510 is closed to energized heater element 502, voltage is applied to heater element 502, and diodes 504, 506. The voltage applied to diodes 504 and 506 during this time creates a voltage bias each time the voltage is applied at the top of both diodes to energize an opto-isolater 510 and activate an input to a micro controller (MCU), The MCU can determine if the heater element 108 or circuit controlling 108 is open. Opto-isolater 510 isolates the MCU and the heater element 502, giving protection to the MCU.

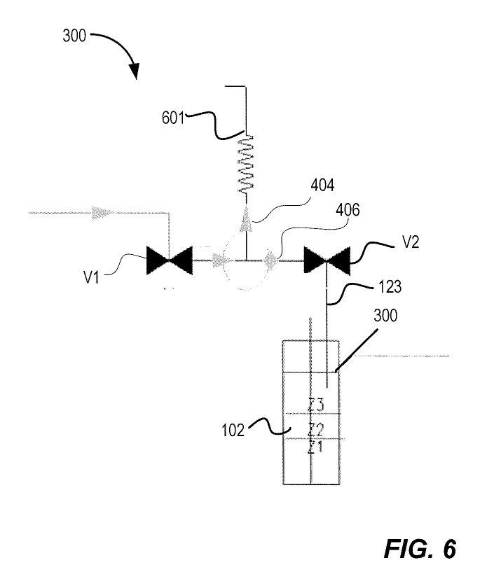

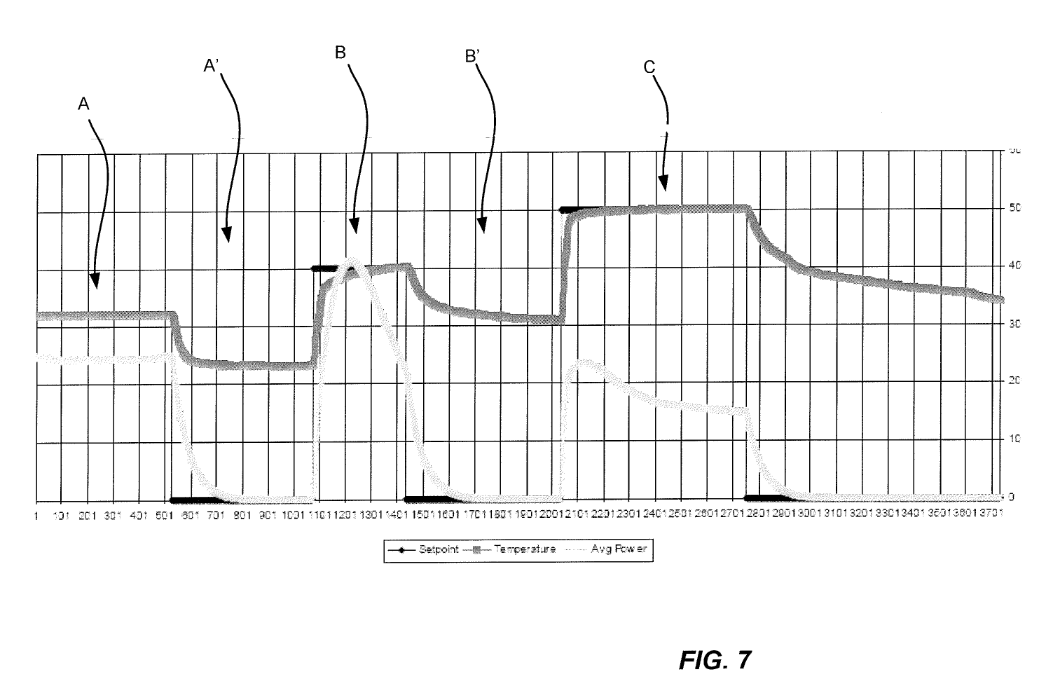

FIG. 6 shows the balancing tee 400 that is used in the evaporation system to isolate the fluid delivery of the inline process from the evaporation process. Operation of valves V1 and V2 is governed by controller 120. Fluid from an inline flow process enters port 402 through V1 and exits through port 404. Port 404 is vented to atmosphere through condenser tubing 601, which also serves a reservoir for the inline flow process. Port 406 is governed through use of valve V2. Negative pressure is applied to vessel 102 through port 300 with commensurate mixing action being achieved through tubing 128 as previously described. Port 406 is unblocked at controllable intervals through the controller 120 by opening V2. The balancing tee 400 allows the fluid in line 601 to be moved into vessel 102 when port 406 is unblocked through V2. Make up airflow is provided through line 601, which is vented to atmosphere. The inline fluid stream in not affected due to the venting of polts 404, 406 during the period that V2 is open. Thus, the inline flow process is not affected by the pressure change when V2 is unblocked.

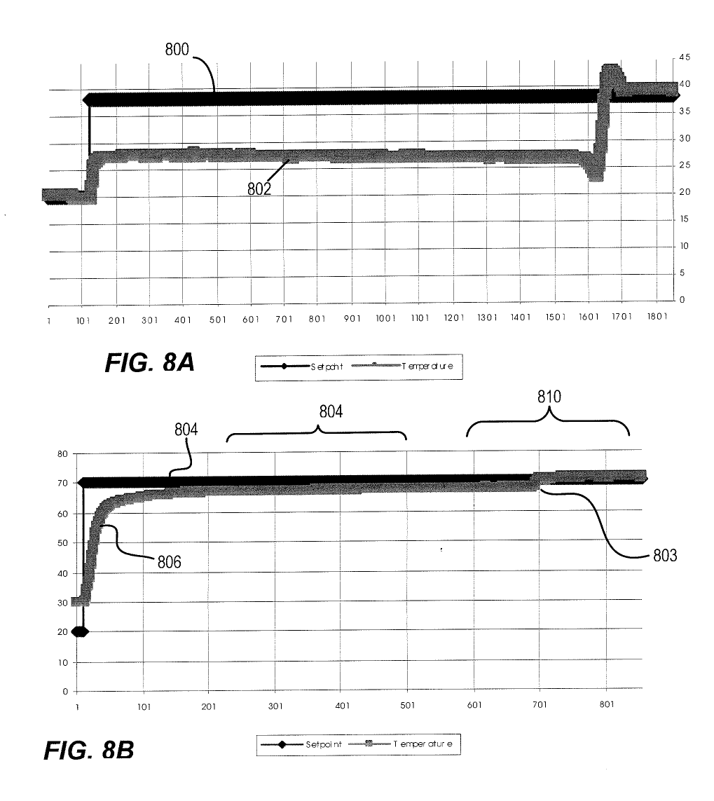

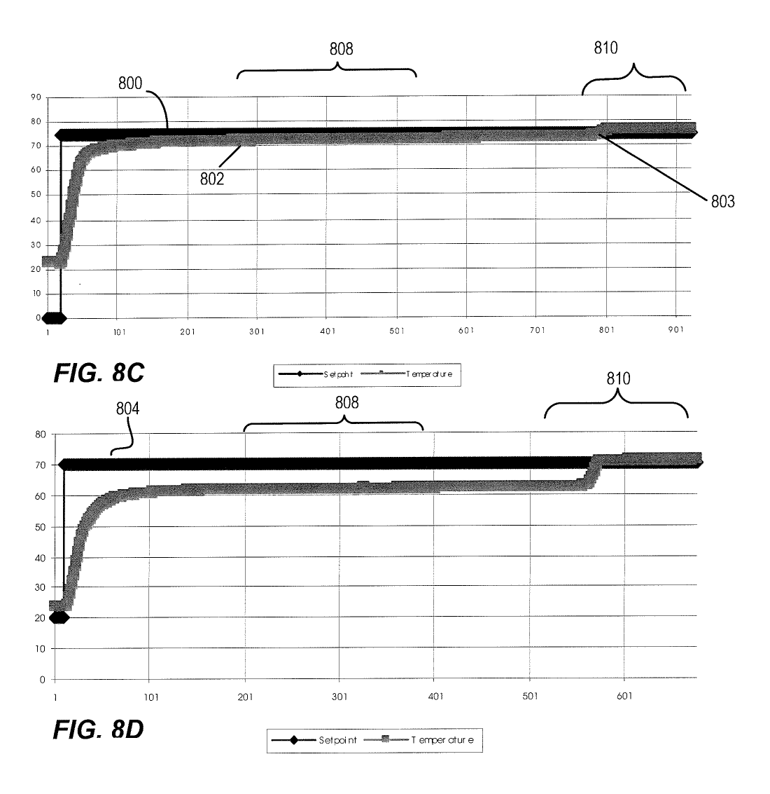

FIG. 8 shows a systematic comparison of temperature values between a set point that is a predetermined temperature value programmable set by controller 120 as an intended value, versus an actual temperature that is measured form the vessel 102. The comparison shows that the intended temperature of the set point is achieved by adjustment of the power that is delivered to the heater 114. The system 100 programmatically determines temperature setpoint targets for each of the stair-stepped intervals from approximately 1 second to 501 seconds, 1101 seconds to 1401 seconds, and 2001 seconds to 2701 seconds, as these represent inherent boiling points of the respective solvents at these times. These boiling points are used to fractionate multiple solvents from a solvent mixture in vessel 102. Accordingly, interval A pertains to partial removal of a dichloromethane (DCM) solvent at a first temperature according to the boiling point of DCM. Hexane is added at interval A′, which raises the boiling point for interval B while the remaining DCM is fractionated from the resultant mixture. No additional solvent is added in interval B′, and hexane solvent is removed at the boiling point of interval C. Thus process completes a solvent exchange from DCM to hexane, with rinsing of vessel 102 by the hexane solvent, followed by partial removal of the hexane solvent to concentrate the materials that are dissolved in the solvent.

FIG. 8A shows an intelligent algorithm through which the controller 120 determines a boiling point of a solution in vessel 102. In this case, a DCM solvent is subjected to heating through use of a PWM-based scaled average power system input under automated control of controller 120. The PWM technique is set at a constant interval intended to produce a temperature 800, which is above the boiling point of DCM. The temperature 802 represents the boiling point of DCM and so is relatively constant (where the DCM is at constant pressure). The sensed temperature 804 jumps at 804 to indicate that the DCM solvent is evaporated, and this jump is interpreted as such by controller 120 to commence the addition of hexane solvent.

FIG. 8B shows the temperature of ethyl acetate solvent in context of a PWM-based scaled average power system input under automated control. This intelligent algorithm includes a set point 804 that matches the boiling point of the solvent, which is at a sensed temperature 806. The controller 120 observes a temperature plateau over interval 808 and matches this to a lookup table of possible setpoints 804 to determine the type of solvent that is being used. Alternatively, the setpoint is set by an operator, perhaps by identifying the type of solvent. The plateau is determined where additional power applied as thermal input to the vessel 102 does not raise the boiling point at constant system pressure. Interval 810 shows that the temperature has risen to the intended setpoint after removal of the solvent.

FIG. 8C shows a Fig. like that of FIG. 8B, but for cyclohexane at a setpoint of 75° C. and 250 Torr.

FIG. 8D shows a Fig. like that of FIG. 8B, but for ethyl acetate/Cyclohexane 1:1 solvent at a setpoint of 70° C. and 250 Torr.

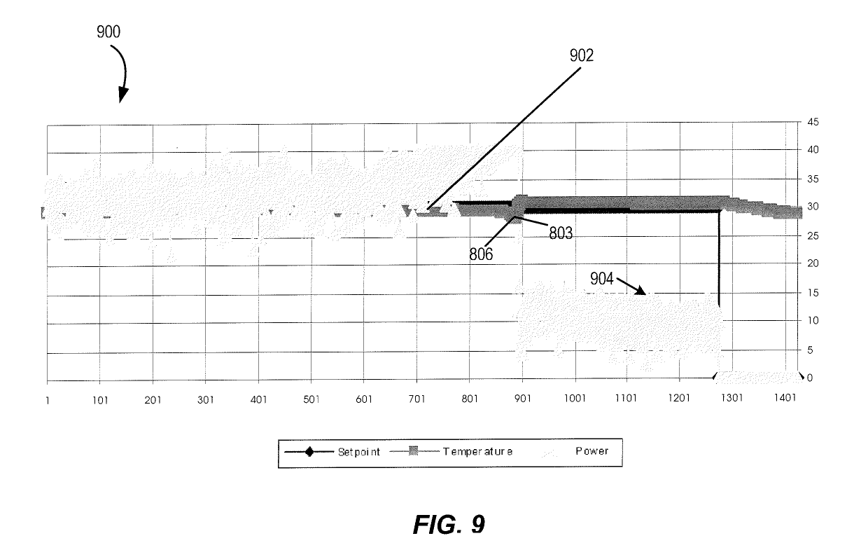

FIG. 9 applies the foregoing principles to illustrate a control algorithm for power limiting to prevent thermal cycling or bumping of the system 100 under automated control. It will be appreciated that the applied power in region 900 is spikey, but generally averages out along the setpoint 804 or boiling point 806. However, at transition 902, this spikiness narrows and trends upward just before the transition at point 803. At this point, system power may be reduced to level 904 though the PWM technique to prevent thermal cycling, since it is no longer necessary to have large excess power for the phase change of he solvent. This is possible or even necessary because the solvent is largely evaporated. If the power is not reduced at this time, there may be miniature eruptions of the solidifying matter within vessel 102, and the interior of vessel 102 becomes increasingly difficulty to clean with each such eruption.

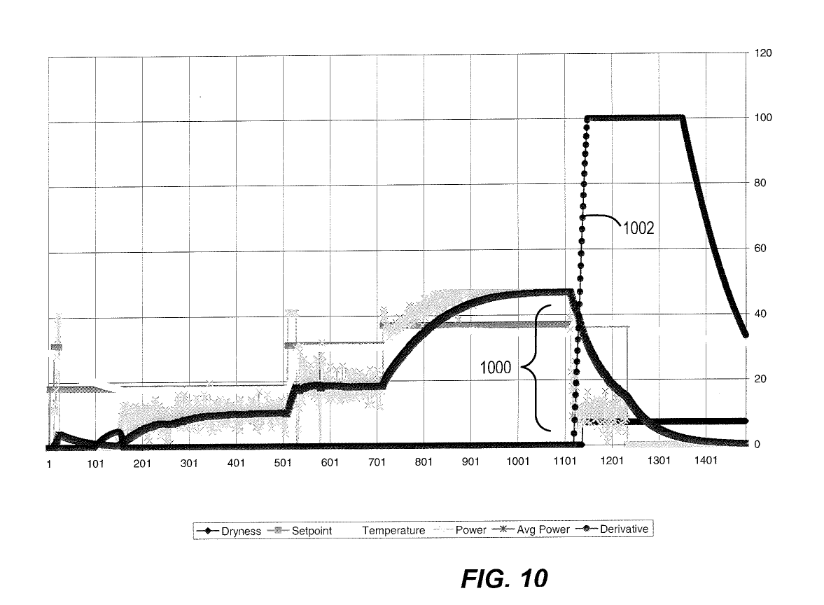

FIG. 10 shows detection of complete fluid dryness under automated control. Dryness is indicated by a steep drop 1000 in the required power input to maintain a given temperature, as is also evident from a derivative 1002 of average power input taken with respect to time. The derivative 1002 may be approximated by a numerical methods technique, such as by averaging power over a time interval and taking a first forward difference of the average values.

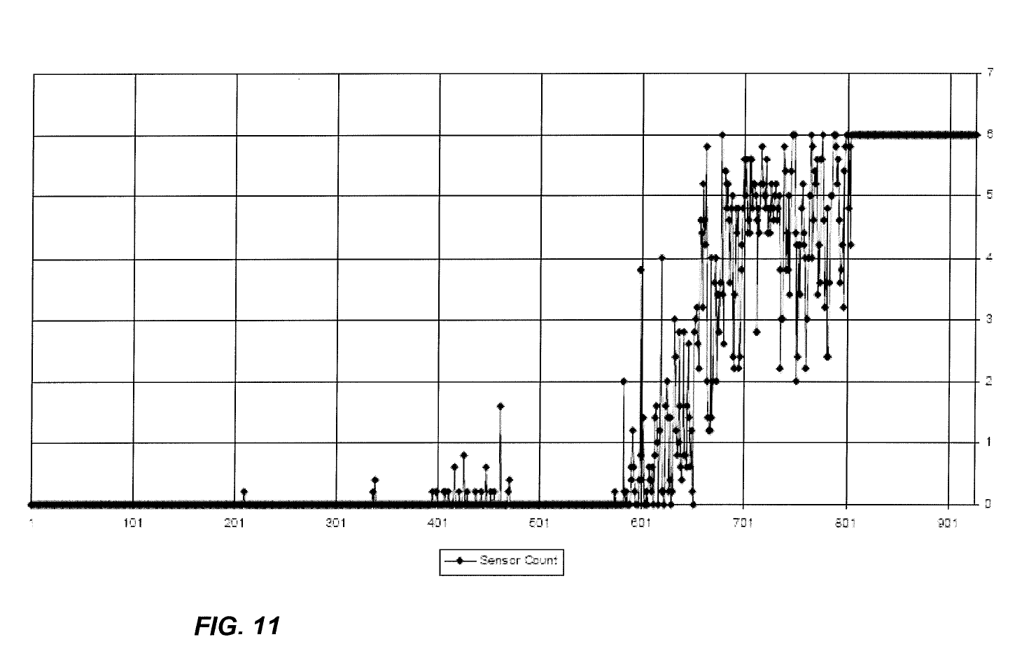

FIG. 11 shows analog to digital signal conversion values for boiling detection or presence of fluid. FIG. 11 presents values that are algorithmically derived from the direct monitoring an analog to digital converter of controller 120 as signal inputs from the level sensors 104 or 106 (see also FIG. 2). An algorithm is derived from the inputs 104 or 106 to provide a change in sensor count, as shown in FIG. 11. The algorithm is determined directly from the number of counts in a monitored time period, e.g., as a period of 100 seconds indicated on the horizontal axis of FIG. 11. At each interval, the count for that interval is compared to the total count for the total elapsed time and converted to a percentage. The detection of boiling or nature of the boiling is derived from the algorithm. A zero count into the algorithm out puts no liquid present. A 100 percent count outputs total blockage or fluid present. A percentage between 0-99 is a relative indicator of the vigor of action in the fluid that is being boiled. The controller 120 may be preprogrammed to limit the vigor of action using this relative indicator.

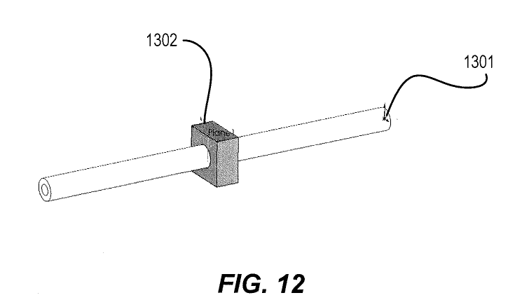

FIG. 12 shows a transport tube 1301 passing through flow sensor 1302. Gas, liquid or intermixed gas and fluid can move through tube 1301. Sensor 1302 is made up of a light source and light source receiver on opposing sides of the transport tube 1301. As material moves through tube 1301 it interrupts the light path and so is detected by the receiver in sensor 302. Algorithmically, the controller 120 monitors the output of the receiver in 1302 and detects the frequency change of the output signal from the detector. This value is compared to a trigger level to determine the presence or non presence of gas, fluid or intermixed gas and fluid in the moving fluid stream. A transport tube 1301 of this nature may be placed in any tube of system 100 to facilitate control instructions that benefit form knowledge that gas and liquid are jointly moving through the tube.

We claim:

1. In a system for solvent evaporation, the improvement comprising:
means for monitoring temperature of the solvent; and
means for using the temperature of the solvent for automated control of a solvent evaporation process over at least one aspect selected form the group consisting of thermal cycling, drying, boiling, and elimination of a solvent that is undergoing evaporation.

2. In a system for solvent evaporation, the improvement comprising:
an automated control system for determining that solvent exchange is complete in a multi-solvent mixture including
means for monitoring temperature of the evaporation vessel to determine if the original fluid is removed when the exchange solvent is the only fluid present in the vessel;
means for applying excess power to the vessel to stabilize the temperature of the vessel at the boiling point of the fluid in the vessel;
means for detecting a temperature rise form the stabilized temperature as the fluid with a lower boiling temperature is evaporated; and
means for detecting a second stabilized temperature when all of the lower boiling fluid is gone, the temperature will stabilize at a higher point.

3. A method for learning what heat rate is required to evaporate a fluid inside an evaporation vessel and save this information for use in future processing, the method comprising the steps of:
adding fluid to the evaporation vessel;
heating the fluid while monitoring the temperature under a known pressure condition;
increasing a rate of heat rate is increased until the temperature is stabilized; and
storing the resultant data for use in future processing of the fluid type.

4. A method for automated self-limiting power that is applied to an evaporating fluid to prevent bumping and thermal cycling, the method comprising the steps of:
heating a solvent liquid; and
controlling the heating by use of a pulse width modulation rate (PWM) to limit an applied heat rate is limited based on the heat rate applied, so not to exceed a maximum peak rate,
where this is done to prevent hysteresis as thermal cycling due to recondensation of liquid before excess vapor is removed in a bumping of the should bumping occur.

5. A method for controlling over-cooling of the evaporation vessel to prevent condensation or icing on the exterior and to prevent vessel damage from thermal stress due to temperature extremes, the method comprising the steps of:
setting a programmable heat rate parameter by user interaction with a control system to control the vessel temperature for purposes of overcoming the cooling effect of negative pressure inside the vessel, the heat rate parameter being effective to establish at least a minimum temperature that effective to prevent freezing or icing, thereby protecting the vessel from temperature swings that otherwise may be caused by freezing or icing;
maintaining the vessel the heat rate parameter to prevent sub-zero to boiling conditions inside the vessel to prevent analyte loss and damage to the vessel.

6. A method for use in a solvent evaporation system under automated control to detect conditions indicating a critical approach to dryness as the fluid evaporates during the final concentration step to prevent loss of volatile analytes, the method comprising the steps of:
heating a solvent-analyte mixture;
algorithmically detecting a rapid change in energy required to keep the vessel at constant temperature as the last of the evaporated fluid leaves the vessel to establish an evaporation endpoint; and
utilizing a user selectable time delay parameter to ensure complete removal of residual vapors in the chamber after endpoint is reached;
the user-selectable time-delay parameter including a threshold value and solvent factor that the user may set for optimization a particular fluid.

7. A method for detecting presence of and the rate of boiling liquid (ebulation) by use of a light source and photo detector placed on opposing sides of the evaporation vessel, the method comprising the steps of:
heating a solvent material;
transmitting an optical signal through the solvent mixture;
detecting the optical signal to provide a detection signal that embodies information representative of the state of the solvent material; and
interpreting the detection signal as an indicator of the state of the solvent material that may be a state of boiling fluid, no fluid present, or non-boiling fluid.

8. A method for creating turbulence in an evaporating fluid, the method comprising the steps of:
introducing a stream of incoming fluid and make up air into a vessel;
placing a negative pressure port off center of the incoming fluid and make up air inlet tube to create a vortex by offsetting the incoming fluid and make up air are offset; and
maintaining a substantially consistent vortex by use of a substantially constant volume of fluids to prevent violent action of the fluid.

9. A method for creating turbulent rinsing within an evaporation vessel, the method comprising the steps of:
introducing rinse fluid and gas to the evaporation vessel;
using negative pressure placed off center of the evaporation vessel to pull the rinse fluid through a center tube from the rinse reservoir;
outgassing the rinse fluid by action of the negative pressure pulling the rinse fluid into a sealed evaporation vessel to create gaps in the rinse fluid;
spraying the rinse fluid into the evaporation vessel to cause such interruptions as an aid to agitation such that the rinse fluid/gas mixture sprays down the vessel walls with force and climbs back up the walls towards the negative pressure port; and
optionally applying heat to create additional agitation and cleaning.

10. A chromatography flow control system comprising:
means for delivering solvent to an evaporation vessel;
means for controlling the solvent delivery to the evaporation vessel without altering the effluent pressure of the fluid stream by use of three flow-balancing orifices;
the flow balancing orifices including an orifice at the exit of the fluid stream where such orifice is smaller than the remaining two orifices placed, which are placed in opposition to one another, the opposing two orifices creating a path for an overflow stream to be collected in a tube at ambient pressures and subsequently drawn into the evaporation chamber feed line under negative pressure without effecting the outflow of the chromatography system or fluid process thus isolating both processes.

11. A circuit with feedback for detection of failed heater element or open circuit, comprising
means for detecting a failure at a rate at which a heater circuit is powered by applying voltage to a heater element and dual inline diodes,
means for creating a voltage bias each time the voltage is applied at the top of both diodes to energize an opto-isolater and activate an input to a micro controller (MCU),
the MCU controlling the rate at which the voltage is applied to the heater and monitoring when the bias voltage should be present; and
means for determining that the circuit is open when the bias voltage is not present as the circuit is energized.

12. A method for determining that the temperature of the evaporation vessel is not increasing when power is applied, the method comprising the steps of:
monitoring a sensor temperature during the application of voltage to a heater element;
stopping application of voltage to the heater element if the temperature does not rise within a specified program time as a safety precaution where the failure to rise indicates the temperature sensor is not attached or a problem is present in the heat and temperature sensing section of the system.

13. A method for detecting the presence or non presence of a moving gas, fluid or an inter-mixed fluid and gas stream in a transport tube by use of a light source and detector placed on opposing sides of the tubing, the method comprising the steps of:
flowing liquid and gas in a tubing;
transmitting an optical signal through the transport tube;
detecting the optical signal to provide a detection signal that embodies presence or non presence of the moving gas, fluid or an inter-mixed fluid and gas stream;
interpreting the detection signal as an indicator of the state of the fluid stream that may be a state of fluid stream present or no fluid stream present;
algorithmically detecting the frequency change of the output signal from the detector; and
comparing the frequency change to a delimiting value as an indicator of the presence or non presence of moving gas, fluid or an inter-mixed fluid and gas stream.
